(19) United States
(12) Patent Application Publication
(10) Pub. No.: US 2025/0105757 A1
(43) Pub. Date: Mar. 27, 2025

(54) THREE-LEVEL POWER SEMICONDUCTOR MODULE AND ARRANGEMENT THEREWITH

(71) Applicant: SEMIKRON DANFOSS ELEKTRONIK GMBH & CO. KG, NUREMBERG (DE)

(72) Inventors: Peter BECKEDAHL, Oberasbach (DE); Andreas WOHLFART, Nuremberg (DE); Mathias SPANG, Nuremberg (DE)

(73) Assignee: SEMIKRON DANFOSS ELEKTRONIK GMBH & CO. KG, NUREMBERG (DE)

(21) Appl. No.: 18/896,662

(22) Filed: Sep. 25, 2024

(30) Foreign Application Priority Data
Sep. 26, 2023 (DE) 10 2023 126 068.5

(51) Int. Cl. H02M 7/487; H02M 7/00; H02M 7/5387

(52) U.S. Cl. CPC H02M 7/487; H02M 7/003; H02M 7/5387

(57) ABSTRACT

A three-level power semiconductor module has a housing, with a switching device, with a first, a second and a third DC voltage terminal element which form a group, with an AC voltage terminal element wherein the switching device is formed as a TNPC circuit arrangement, which has a DC branch with an upper first switch, with a lower fourth switch and with a center tap and a T branch with a second switch and with a third switch connected in series with the second switch, wherein the first switch is formed of a plurality of first part switches, a majority of these part switches lie in the direction from the group of DC voltage terminals to the AC voltage terminal on a first straight line wherein the fourth switch is formed of a plurality of fourth part switches, wherein a majority of these part switches lie in the direction from the group of DC voltage terminals to the AC voltage terminal on a second straight line adjacent to the first and the focal points of the second and third switch lie in the direction from the group of DC voltage terminals to the AC voltage terminal on a third straight line.

### CROSS REFERENCE TO RELATED APPLICATIONS

This application relates to and claims priority to DE 10 2023 126 068.5 filed Sep. 26, 2023, the entire contents of which are incorporated herein fully by reference.

### BACKGROUND OF THE INVENTION

### Field of the Invention

The invention describes a three-level power semiconductor module with a housing, with a switching device, with a first, a second and a third DC voltage terminal element which form a group, and with an AC voltage terminal element wherein the switching device has a normal direction and is formed as a TNPC circuit arrangement. The invention furthermore describes an arrangement with such three-level power semiconductor modules.

### Description of the Related Art

DE 10 2017 115 883 A1 discloses a submodule and an arrangement therewith, wherein the submodule has a switching device with a substrate and conductor tracks arranged thereon. The submodule has a first and a second DC voltage conductor track and, electrically conductively connected thereto, a first and a second DC voltage terminal element, and an AC voltage conductor track and, electrically conductively connected thereto, an AC voltage terminal element. The submodule furthermore has an insulating-material moulded body, which encloses the switching device like a frame. The first DC voltage terminal element lies with a first contact section on a first support body of the insulating-material moulded body, the AC voltage terminal element lies with a second contact section on a second support body of the insulating-material moulded body. A first clamping device is designed to extend through a first cut-out in the first support body in an electrically insulated manner and to form an electrically conductive clamping connection between the first DC voltage terminal element and an assigned first DC voltage connecting element and a second clamping device is designed to extend through a second cut-out in the second support body in an electrically insulated manner and to form an electrically conductive clamping connection between the AC voltage terminal element and an assigned AC voltage connecting element.

### ASPECTS AND OBJECTS OF THE INVENTION

At least one of the objects of the present invention is to provide an improvement over the related art.

The invention is based on the object of developing the prior art such that the switches of a switching device formed as a three-level circuit arrangement in half-bridge topology are arranged in a housing with DC voltage terminal elements on a narrow side and an AC voltage terminal element on an opposite narrow side in such a way that inductances during commutation are minimized.

This object is achieved, according to the invention, by a three-level power semiconductor module with a housing, with a switching device, with a first, a second and a third DC voltage terminal element which form a group, and with an AC voltage terminal element wherein the switching device has a normal direction and is formed as a TNPC circuit arrangement, which has a DC branch with an upper first switch whose power input is connected to a high potential of a DC voltage source with a lower fourth switch whose power output is connected to a low potential of a DC voltage source and with a center tap and a T branch with a second switch whose power input is connected indirectly or directly to intermediate potential and with a third switch, connected in series with the second switch, whose power input is connected indirectly or directly to the center tap, wherein the first switch is formed of a plurality of first part switches, wherein a majority, preferably all, of these part switches lie in the direction from the group of DC voltage terminals to the AC voltage terminal on a first straight line wherein the fourth switch is formed of a plurality of fourth part switches, wherein a majority, preferably all, of these part switches lie in the direction from the group of DC voltage terminals to the AC voltage terminal on a second straight line adjacent to the first and the focal points of the second and third switch lie in the direction from the group of DC voltage terminals to the AC voltage terminal on a third straight line.

The term “the switching device” should be understood to mean, in particular, one or more customary power electronic substrates with customary power semiconductor components arranged thereon and a customary internal connecting device, which is formed in particular as wire bond connections or as a foil stack of conductive and insulating foils which are structured in themselves.

The term “a direct connection to a potential” is understood to mean, in particular, that a terminal element of a power semiconductor module is directly connected to a conductor track on which a switch is arranged. The term “an indirect connection to a potential” is understood to mean, in particular, that a terminal element of a power semiconductor module is connected, via a further component, an internal connecting device by way of example, to a conductor track on which a switch is arranged.

The term which states that “a part switch lies on a straight line” should be understood to mean that the straight line runs through the area of the part switch, or in other words, that the straight line intersects the circumferential edge of the part switch at two points.

The term “the adjacent straight lines” should be understood to mean, in particular, two straight lines which lie in one plane and intersect one another at a point which does not lie inside the periphery of the power semiconductor module.

A straight line from the group of DC voltage terminals to the AC voltage terminal should be understood to mean a straight line which extends, in projection in the normal direction, both through the group as a whole and through the AC voltage terminal, that is to say intersects the respective areas.

It is preferred if the current-carrying capacity of all the switches is identical or the current-carrying capacity of the first and fourth switch is identical to and greater than that of the second and third switch, respectively.

It is furthermore preferred if the third straight line makes an angle of less than 45°, preferably of less than 25°, with the first and second straight line in each case.

It is particularly preferred if the respective switch is formed as a power semiconductor component or as a group of power semiconductor components connected in parallel, wherein the respective power semiconductor component is formed as an IGBT, preferably with antiparallel-connected diodes, or a MOS-FET, in particular as a SiC-MOS-FET, or as an HEMT, in particular as a GaN-HEMT.

It may be preferred if respective connection surfaces of the DC voltage terminal elements have an identical normal direction, are arranged next to one another in projection in the normal direction and the third connection surface of the third DC voltage terminal element lies in a first plane and the first connection surface of the first DC voltage terminal element lies in a second plane parallel to the first when viewed in the normal direction. It may be preferred if the second connection surface of the second DC voltage terminal element lies in the second plane when viewed in the normal direction.

In principle, it may be preferred if the first DC voltage terminal element is intended to be connected to the high potential, wherein the second DC voltage terminal element is intended to be connected to the low potential and wherein the third DC voltage terminal element is intended to be connected to the intermediate potential.

In particular, it may be advantageous if all the connection surfaces lie next to one another, although not in series, in projection in the normal direction.

It may, in principle, be advantageous if a first line section of the first DC voltage terminal element, which is connected directly to the first connection surface, aligns at least in sections with the third connection surface of the third DC voltage terminal element in the normal direction, as a result of which a stack is formed locally. It may also be advantageous if a second line section of the second DC voltage terminal element, which is connected directly to the second connection surface, aligns at least in sections with the third connection surface of the third DC voltage terminal element in the normal direction and likewise forms a stack locally.

It is advantageous if all the DC voltage terminal elements are arranged on a first narrow side of the housing. In particular, it is advantageous if the AC voltage terminal element is arranged on a second narrow side of the housing opposite the first.

It may be advantageous if the DC voltage terminal element and advantageously also the AC voltage terminal element are formed as a metal foil or a metal sheet, having a thickness of preferably 300 μm to 2000 μm, in particular preferably of 500 μm to 1500 μm.

It may additionally be preferred if a centrally arranged fastening cut-out extends through the switching device.

The object is furthermore achieved by a power electronic arrangement with a plurality of three-level power semiconductor modules, wherein all the three-level power semiconductor modules are arranged with their longitudinal sides next to one another in a row and wherein the DC voltage terminal elements of all the three-level power semiconductor modules are preferably likewise arranged in a row.

It may be advantageous if all the respective DC voltage terminal elements are connected in a polarity-appropriate manner to common, respectively assigned DC voltage supply line elements of a DC voltage supply line device.

It is understood that the different configurations of the invention may be realized individually or in any desired combinations to achieve improvements. In particular, the features mentioned and explained above and hereinafter may be used not only in the specified combinations but also in other combinations or in isolation, without departing from the scope of the present invention and regardless of whether they are disclosed in the context of the three-level power semiconductor module or the arrangement.

The above and other aspects, features, objects, and advantages of the present invention will become apparent from the following description read in conjunction with the accompanying drawings for exemplary but nonlimiting embodiments, in which like reference numerals designate the same elements.

### BRIEF DESCRIPTION OF THE DRAWINGS

FIG. 1 schematically shows a TNPC circuit topology.

FIG. 2 shows a plan view of a first configuration of a three-level power semiconductor module.

FIGS. 3 and 4 show plan views of a second configuration of a three-level power semiconductor module.

FIGS. 5 and 6 show plan views of a third configuration of a three-level power semiconductor module.

FIG. 7 shows a detail of the DC voltage terminal elements and of a housing of the first configuration of the three-level power semiconductor module according to the invention.

FIG. 8 shows the first configuration of the three-level power semiconductor module according to the invention in a three-dimensional schematic view.

FIG. 9 shows an arrangement according to the invention.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ or ‘bond’ or and similar terms do not necessarily denote direct and immediate connections, but also include connections through intermediate elements or devices. For purposes of convenience and clarity only, directional (up/down etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

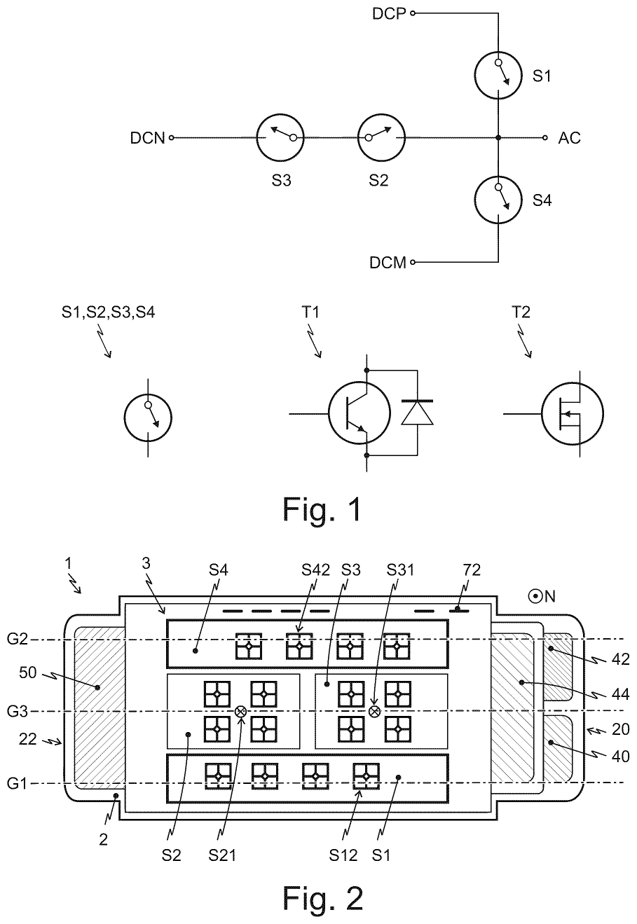

FIG. 1 shows a configuration of a TNPC (T-type Neutral Point Converter) circuit topology, in particular a 3-level inverter half-bridge. The circuit has a DC branch with an upper first switch S1, wherein the power input of the first switch S1 is connected to a high, here positive, potential DCP of a DC voltage source. The DC branch furthermore has a lower fourth switch S4, wherein the power output of the fourth switch S4 is connected to a low, here negative, potential DCM of a DC voltage source. The half-bridge circuit has a center tap AC between the first and fourth switch S1,S4. The center tap AC is connected to an AC voltage terminal 50, which has AC potential during operation.

In FIG. 1, furthermore a T branch with a second switch S2 is depicted, wherein the power output of the second switch S2 is connected directly to the center tap, by way of example here. The T branch moreover has a third switch S3. The power output of the third power semiconductor switch S3 here is connected directly to an intermediate potential DCN, which is formed as a basic potential here. The power input of the second switch S2 and the power input of the third switch S3 are electrically connected to one another.

The first, second, third and fourth switch S1,S2,S3,S4 is formed, by way of example here, as an IGBT T1 antiparallel-connected diode or as a parallel circuit of a plurality of IGBTs with antiparallel-connected diodes. The collector terminal of the respective IGBT forms the load input, the emitter terminal forms the load output and the gate terminal forms the control input. The respective power semiconductor switches may alternatively also each be formed as a MOS-FET T2, preferably as a MOS-FET with a large band gap, that is to say as a SiC-MOS-FET, or as an HEMT or as a GaN-HEMT. In addition, a parallel circuit of a plurality of MOS-FETs is possible. Then, the drain terminal forms the load input, the source terminal forms the load output and the gate terminal forms the control input, respectively.

FIG. 2 shows a plan view of a first configuration of a three-level power semiconductor module 1 with a housing 2, with a schematically depicted switching device 3, with a first, a second and a third DC voltage terminal element 40,42,44 which form a group, and with an AC voltage terminal element 50. The switching device 3, more precisely the substrate thereof, has a normal direction N. The switching device 3 itself is formed as a TNPC circuit arrangement in half-bridge topology, as depicted in FIG. 1. Further details, such as conductor tracks on the substrate, are not depicted for reasons of clarity.

This switching device 3 thus has a DC branch with an upper first switch S1 and with a lower fourth switch S4. It furthermore has a T branch with a second switch S2 and with a third switch S3. The first switch S1 is formed of four first part switches S12, wherein all the first part switches S12 lie on a first straight line G1, which runs in the direction from the group of DC voltage terminals 40,42,44 to the AC voltage terminal 50. The fourth switch S4 is also formed of four fourth part switches S42, wherein all the fourth part switches S42 lie on a second straight line G2 adjacent to the first, which runs in the direction from the group of DC voltage terminals 40,42,44 to the AC voltage terminal 50. The respective part switches are formed by a power semiconductor switch, here a MOS-FET in silicon carbide technology.

The second and third power semiconductor switches S2,S3 each form a group with a focal point S21,S22. With four identical power semiconductor switches in the corners of a rectangle, this focal point S21,S22 is in the center of the rectangle. The second and third switch S2,S3 is in each case formed by four power semiconductor switches, here four MOS-FETs in silicon carbide technology. The focal points S21,S31 of the second and third switch S2,S3 lie on a third straight line G3, which runs in the direction from the group of DC voltage terminals 40,42,44 to the AC voltage terminal 50. All the straight lines G1,G2,G3 of this configuration run parallel to one another.

The first DC voltage terminal element 40 of this configuration of a three-level power semiconductor module 1 is intended, purely by way of example, to be connected to the high potential DCP of a DC voltage source, while the second DC voltage terminal element 42 is intended to be connected to the low potential DCM of the DC voltage source and the third DC voltage terminal element 44 is intended to be connected to the intermediate potential DCN, cf. FIG. 1 in each case.

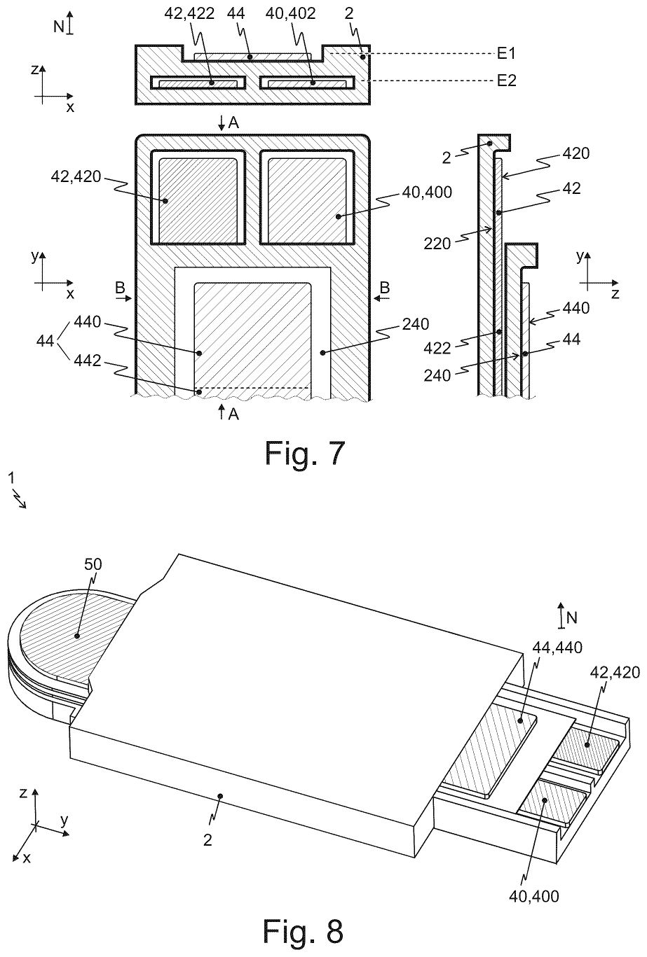

Each of the DC voltage terminal elements 40,42,44 has a connection surface 400,420,440, which is contactable from the normal direction N. For the precise location of the DC voltage terminal elements 40,42,44 and the respectively assigned connection surfaces 400,420,440, compare FIG. 7. Thus, the respective connection surfaces 400,420,440 of the DC voltage terminal elements 40,42,44 point in the same normal direction N, are arranged next to one another, but not in series, in projection in the normal direction N.

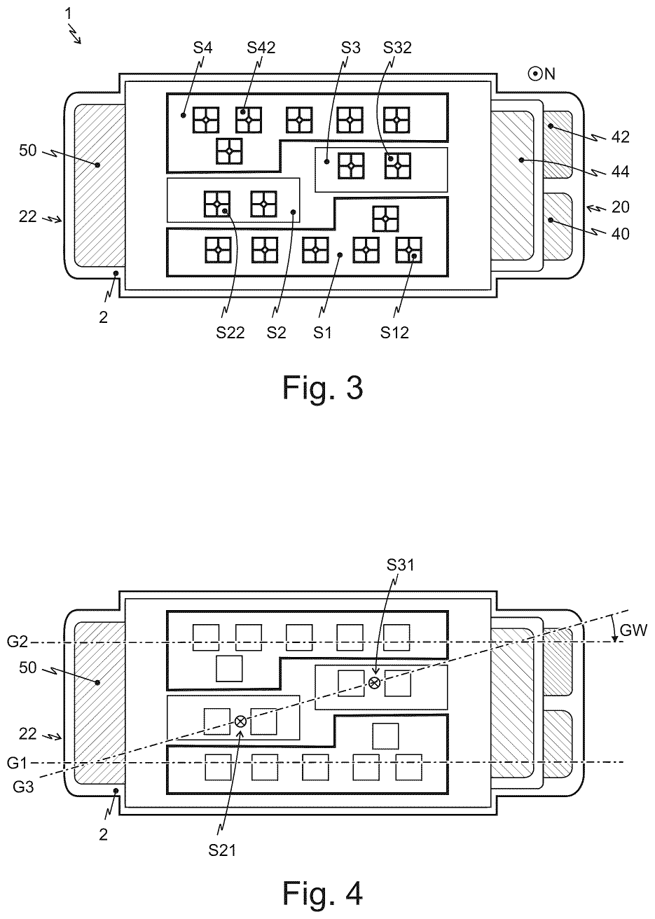

FIGS. 3 and 4 show plan views of a second configuration of a three-level power semiconductor module 1. This differs from that of FIG. 2 in particular by the arrangement of the part switches S12,S42 of the respective first and fourth switch S1,S4. The first and fourth switch S1,S4 is in each case formed of six part switches S12,S42, each formed as a power semiconductor component. Five of these six part switches S12,S42, that is to say the majority, of the respective part switches S12,S42 of the first and fourth switch S1,S4 lie on a straight line G1,G2, which runs in the direction from the group of DC voltage terminals 40,42,44 to the AC voltage terminal 50. The first straight line G1 assigned to the first switch S1 and the second straight line G2 assigned to the fourth switch S4 run parallel to one another here.

The second and third switch S2,S3 is in each case formed of two power semiconductor components. The focal points S21,S31 of the second and third switch S2,S3 are arranged on a third straight line G3, which runs in the direction from the group of DC voltage terminals 40,42,44 to the AC voltage terminal 50. The third straight line G3 makes an angle GW of between 15° and 25° with both the first and the second straight line G1,G2.

This configuration of the respective switches S1,S2,S3,S4, specifically the number of power semiconductor components, may be advantageous in the case of specific load-dependent activation methods of the three-level power semiconductor module 1.

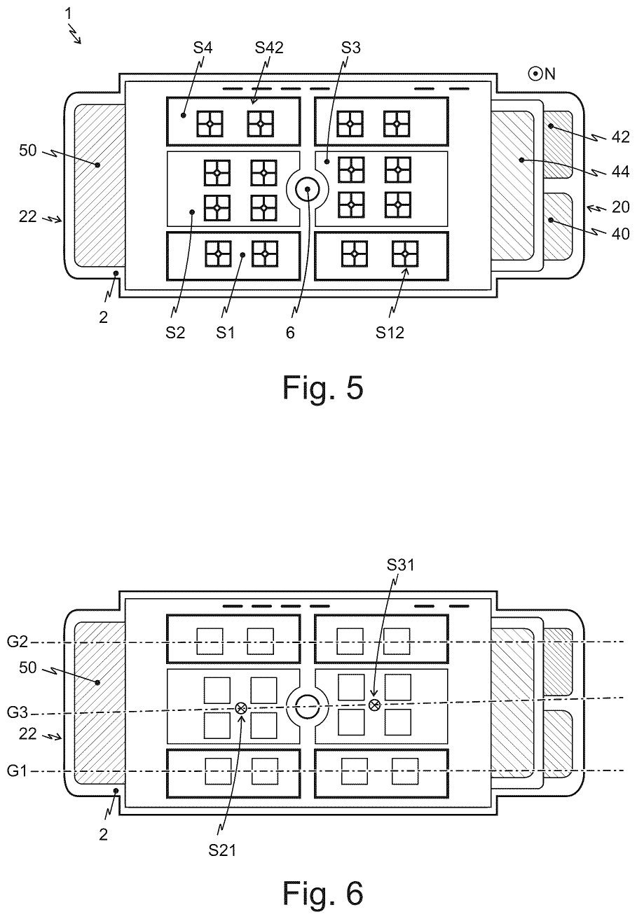

FIGS. 5 and 6 show plan views of a third configuration of a three-level power semiconductor module 1. This differs from that of FIG. 2 in particular by the arrangement of the part switches S12,S42 of the first and fourth switch S1,S4. The first and fourth switch S1,S4 is in each case formed of two groups of four part switches S12,S42. A group of part switches S12,S42 of the first and fourth switch S1,S4 is arranged on a substrate together with the second switch S2, while the other group of part switches of the first and fourth switch S1,S4 is arranged on a further substrate together with the third switch S3.

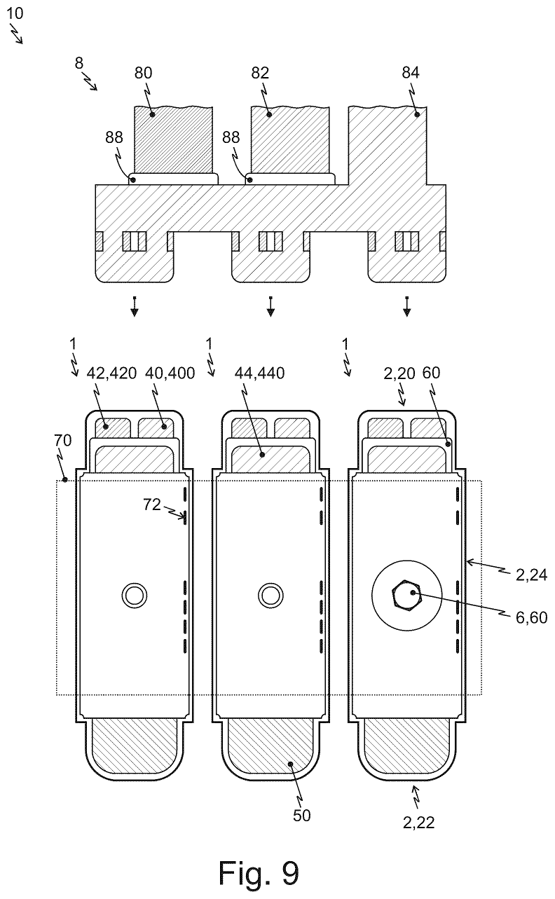

In addition, the housing 2 also has a continuous fastening cut-out 6 for arranging a fastening device 60, cf. FIG. 9. The third straight line G3 makes an angle GW of less than 10° here with the two parallel first and second straight lines, with the result that the intersection of the third straight line G3 with the remaining straight lines G1,G2 lies outside the area of the three-level power semiconductor module 1.

FIG. 7 shows a detail of the DC voltage terminal elements 40,42,44 and of a housing 2 of the first configuration of the three-level power semiconductor module 1 according to the invention in three orthogonal views. The three DC voltage terminal elements 40,42,44 are depicted, whose connection surfaces 400,420,440 all have the same normal direction N, here the z direction, and a section of the associated housing 2 is also depicted, cf. also FIG. 8.

The sectional view above the plan view shows a section along the line B-B and the sectional view next to the plan view shows a section along the line A-A.

The housing 2 is formed as an insulating-material housing, in particular a plastic housing and has on its first narrow side 20 a first and a second bearing surface 200,220, respectively. The first DC voltage terminal element 40 is arranged on the first bearing surface 200 and the second DC voltage terminal element 42 is arranged on the second bearing surface 220, wherein these bearing surfaces 200,220 are also orientated in the normal direction N. The first and the second DC voltage terminal element 40,42 are arranged on one of these bearing surfaces 200,220, respectively. Their respective connection surfaces 400,420 thus lie in a second plane E2 and are arranged next to one another there.

The housing 2 furthermore has a third bearing surface 240 for the third DC voltage terminal element 44, wherein this third bearing surface too is orientated in the normal direction N. The third DC voltage terminal element 44 is arranged on this third bearing surface 240, and therefore its third connection surface 440 too is orientated in the normal direction N. Thus, all the connection surfaces 400,420,440 of the DC voltage terminal elements 40,42,44 are orientated in the normal direction N. In addition, the bearing surface 440 of the third DC voltage terminal element 44 is set back in the negative y direction and arranged in a first plane E1, parallel to the second, which is arranged in the negative normal direction N, that is to say also in the negative z direction above the second plane E2. With this configuration of the housing 2 and with this arrangement of the DC voltage terminal elements 40,42,44, all three connection surfaces 400,420,440 of the three DC voltage terminal elements 40,42,44 lie next to one another, although not in a row.

This means that a first line section 402, directly adjoining the first connection surface 400, of the first DC voltage terminal element 40 aligns in sections with the third connection surface 440 of the third DC voltage terminal element 44 in the normal direction N. Simultaneously and symmetrically thereto, a second line section 422, directly connected to the second connection surface 420, of the second DC voltage terminal element 42 aligns in sections with the third connection surface 440 of the third DC voltage terminal element 44 in the normal direction N.

This configuration results in a low-inductance configuration in each case both for the combination of first and third DC voltage terminal element 40,44 and for the combination of second and third DC voltage terminal element 42,44.

Of course the housing 2, or additional insulation elements in conjunction with the housing 2, is formed in such a way that the respective DC voltage terminal elements 40,42,44 are arranged sufficiently electrically insulated from one another.

FIG. 8 shows the first configuration of the three-level power semiconductor module 1 according to the invention in a three-dimensional schematic view. A substantially cuboid housing 2 is depicted, wherein all the DC voltage terminal elements 40,42,44 are arranged on its first narrow side 20, while the AC voltage terminal element 50 is arranged on a second narrow side 22. This configuration allows several three-level power semiconductor modules 1 to be arranged next to one another in a very space-saving manner, cf. FIG. 9.

The specific configuration and arrangement of the DC voltage terminal elements 40,42,44 corresponds to that of FIG. 7.

The DC voltage terminal elements 40,42,44 and the AC voltage terminal element 50 of this three-level power semiconductor module 1 are formed as a metal sheet, having a thickness of 1 mm.

FIG. 9 shows an arrangement according to the invention, wherein three three-level power semiconductor modules 1 are arranged with their longitudinal sides 24 next to one another here. The DC voltage terminal elements 40,42,44 of all the three-level power semiconductor modules 1 are arranged on the same, the first, narrow side 20.

Furthermore, three DC voltage supply line elements 80,82,84 are depicted, which are arranged in stacked sections and form the DC voltage supply line 8 of a capacitor device which is not depicted. For reasons of clarity, the DC voltage supply line elements 80,82,84 are spaced apart from the three-level power semiconductor modules 1. The respective DC voltage supply line element 80,82,84 is connected in a polarity-appropriate manner to a respectively assigned DC voltage terminal element 40,42,44.

Of course, both the DC voltage terminal elements 40,42,44 and the DC voltage supply line elements 80,82,84 have an insulation device 60,88 for electrically insulating the elements of differing polarity.

Furthermore, two of the DC voltage supply line elements 82,84 have cut-outs which are designed and intended for a laser beam acting from a negative normal direction to be able to act upon a DC voltage supply line element 80,82, arranged therebelow, through these cut-outs. A laser-welded connection formed in this way results in a permanently materially-bonded connection between a DC voltage supply line element and an assigned DC voltage terminal element in each case.

Each three-level power semiconductor module 1 furthermore has auxiliary terminal elements 72, cf. also FIGS. 2 to 6, which are each arranged along one or both longitudinal sides. These auxiliary terminal elements 72 are used for electrically conductive connection to a driver device 70 common to all power semiconductor modules 2,4. This covers, partially in each case, all three-level power semiconductor modules 1.

Each three-level power semiconductor module 1 has a centrally arranged fastening cut-out 6, which extends through the switching device and further components following in the normal direction N. A section of a fastening device 60, in particular of a screw, which attaches the respective three-level power semiconductor module 1 on a cooling device, not depicted, preferably a liquid cooling device, is arranged in this fastening cut-out 6.

Also, the inventors intend that only those claims which use the specific and exact phrase “means for” are intended to be interpreted under 35 USC 112. The structure, device, and arrangement herein is noted and well supported in the entire disclosure. Moreover, no limitations from the specification are intended to be read into any claims, unless those limitations are expressly included in the claims.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure covers modifications and variations of this disclosure provided they come within the scope of the appended claims and their equivalents.

What is claimed is:

1. A three-level power semiconductor module (1), comprising:
a housing (2), with a switching device (3), with a first, a second and a third DC voltage terminal element (40,42,44) which form a group of DC voltage terminals (40, 42, 44);
an AC voltage terminal element (50);
the switching device (3) has a normal direction (N) and is formed as a TNPC circuit arrangement, which has a DC branch with an upper first switch (S1) whose power input is connected to a high potential (DCP) of a DC voltage source;
a lower fourth switch (S4) whose power output is connected to a low potential (DCM) of a DC voltage source and with a center tap (AC) and a T branch with a second switch (S2), whose power input is connected indirectly or directly to intermediate potential (DCN) and with a third switch (S3), connected in series with the second switch (S2), whose power input is connected indirectly or directly to the center tap (AC);
wherein the first switch (S1) is formed of a plurality of first part switches (S12);
wherein a majority of the part switches (S12) lie in a direction from the group of DC voltage terminals (40,42,44) to the AC voltage terminal (50) on a first straight line (G1);
wherein the fourth switch (S4) is formed of a plurality of fourth part switches (S42); and
wherein a majority of the fourth part switches (S42) lie in a direction from the group of DC voltage terminals (40,42,44) to the AC voltage terminal (50) on a second straight line (G2) that is adjacent to respectively a first point and a focal point (S21,S31) of the second and third switch (S2,S3) that lie in the direction from the group of DC voltage terminals (40,42,44) to the AC voltage terminal (50) on a third straight line (G3).

2. The three-level power semiconductor module, according to claim 1, wherein:
the current-carrying capacity of all the switches (S1,S2,S3,S4) is identical or the current-carrying capacity of the first and fourth switch (S1,S4) is identical to and greater than that of the second and third switch (S2,S3), respectively.

3. The three-level power semiconductor module, according to claim 1, wherein:
the third straight line (G3) makes an angle (GW) of less than 45° with the first and second straight line (G1,G2), in each case.

4. The three-level power semiconductor module, according to claim 1, wherein:
the respective switch (S1,S2,S3,S4) or part switch (S12,S42) is formed as a power semiconductor component or as a group of power semiconductor components connected in parallel; and
the respective power semiconductor component is formed as one of an IGBT (T1), an IGBT with antiparallel-connected diodes, a MOS-FET (T2), a SiC-MOS-FET, a HEMT, and a GaN-HEMT.

5. The three-level power semiconductor module, according to claim 1, wherein:
the respective connection surfaces (400,420,440) of the respective DC voltage terminal elements (40,42,44) each have an identical normal direction (N), and are arranged next to one another in projection in the normal direction (N);
wherein the third connection surface (440) of the third DC voltage terminal element (44) lies in a first plane (E1); and
the first connection surface (400) of the first DC voltage terminal element (44) lies in a second plane (E2) parallel to the first when viewed in the normal direction (N).

6. The three-level power semiconductor module, according to claim 5, wherein:
the second connection surface (420) of the second DC voltage terminal element (42) lies in the second plane (E2) when viewed in the normal direction (N).

7. The three-level power semiconductor module, according to claim 1, wherein:
the first DC voltage terminal element (40) is connected to the high potential (DCP);
the second DC voltage terminal element (42) is connected to the low potential (DCM); and
the third DC voltage terminal element (44) is connected to the intermediate potential (DCN).

8. The three-level power semiconductor module, according to claim 1, wherein:
all the connection surfaces (400,420,440) lie next to one another, in a projection in the normal direction (N) and not in series.

9. The three-level power semiconductor module, according to claim 5, wherein:
a first line section (402) of the first DC voltage terminal element (40), is connected directly to the first connection surface (400), and aligns at least in sections with the third connection surface (440) of the third DC voltage terminal element (44) in the normal direction (N).

10. The three-level power semiconductor module, according to claim 5, wherein:
a second line section (422) of the second DC voltage terminal element (42), is connected directly to the second connection surface (420), and aligns at least in sections with the third connection surface (440) of the third DC voltage terminal element (44) in the normal direction (N).

11. The three-level power semiconductor module, according to claim 1, wherein:
all the DC voltage terminal elements (40,42,44) are arranged on a first narrow side (20) of the housing (2).

12. The three-level power semiconductor module, according to claim 1, wherein:
the AC voltage terminal element (50) is arranged on a second narrow side (22) of the housing (2).

13. The three-level power semiconductor module, according to claim 1, wherein:
a centrally arranged fastening cut-out (6) extends through the switching device.

14. A power electronic arrangement (10), comprising:
a plurality of three-level power semiconductor modules (1), according to claim 1, wherein:
each of the plurality of three-level power semiconductor modules (1) are arranged with their longitudinal sides (24) next to one another in a row; and
wherein the DC voltage terminal elements (40,42,44) of all the three-level power semiconductor modules (1) are also arranged in a row.

15. The power electronic arrangement, according to claim 14, wherein:
each of the respective DC voltage terminal elements (40,42,44) are connected in a polarity-appropriate manner to common, respectively assigned DC voltage supply line elements (80,82,84) of a DC voltage supply line device (8).
